(19) United States
(12) Patent Application Publication
(10) Pub. No.: US 2009/0174561 A1
(43) Pub. Date: Jul. 9, 2009

(54) System and Method for Transmitting Security Information Over a Passive Optical Network

(75) Inventors: David Hwa-Wei Liu, Herndon, VA (US); Guy M. Merritt, Purcellville, VA (US); Douglas A. Atkinson, Ashburn, VA (US); Fung-Chang Huang, Herndon, VA (US); Marc R. Bernard, Miramar, FL (US)

Correspondence Address: THE SMALL PATENT LAW GROUP LLP, 225 S. MERAMEC, STE. 725T, ST. LOUIS, MO, 63105, US

(73) Assignee: TELLABS OPERATIONS, INC., Naperville, IL (US)

(21) Appl. No.: 11/969,609

(22) Filed: Jan. 4, 2008

(51) Int. Cl. G08B 17/12

(52) U.S. Cl. 340/578

(57) ABSTRACT

An optical network terminal (ONT) includes an input device coupled to at least one sensing device mounted in a structure, and an output coupled to a passive optical network (PON). The ONT also includes a processor programmed to receive security information from the input device, determine if an alarm condition exists using the security information, and transmit an alarm to the output based on the determination. The processor is programmed to detect an open circuit between the sensing device and the ONT, and to generate an alarm if an open circuit is detected. The processor is also programmed to receive information from a keypad located remotely from the ONT. The keypad is utilized to program the ONT from the remote location.

### BACKGROUND OF THE INVENTION

The present invention generally relates to a home or business security system and more particularly to systems and methods for integrating a security system into an optical network terminal (ONT).

Security systems are utilized in a variety of applications to monitor both residential and commercial structures. Known security systems include a master control panel, a plurality of sensors coupled directly to the master control panel, and a keypad that is used by a customer to control the security system. The master control panel communicates with a Central Alarm Monitoring Center as discussed below. The keypad may be used to arm or disarm the security system, program the alarm system to be armed for certain hours of the day, etc. The master control panel is typically mounted inside the customer's premise in the garage or basement, for example. The keypad is typically mounted on a wall that can be easily accessed by the customer. The sensors are coupled directly to the master control panel using copper wiring. During operation, the security system monitors one or more remote components using the installed sensors. Based on feedback from the installed sensors, various security and emergency related functions are carried out.

One known method of transmitting signals from the master control panel to the Central Alarm Monitoring Center is to couple the master control panel to the Central Alarm Monitoring Center using existing phone lines. For example, once the security service is activated and the security system is armed, all installed sensors will be activated and listen for triggering activities. When a sensor is triggered, the sensor sends a signal to the Master Control Panel. The Master Control Panel then dials out to the Central Alarm Monitoring Center using the existing phone line that is attached to the Master Control Panel. Once the Central Alarm Monitoring Center is notified that an alarm is triggered at the customer's premise, the Central Alarm Monitoring Center contacts the owner and/or the proper authorities. However, phone line connectivity is not always reliable.

Other known security systems utilize an optical network to transmit information from the master control panel to the Central Alarm Monitoring Center. Optical networks are widely used to transmit Video/Voice/Data to the customer. One known optical network is a Passive Optical Network (PON). A PON typically includes a central office node, referred to as an optical line terminal (OLT) and one or more remote nodes, referred to as optical network terminals (ONTs) or as optical network units (ONUs). An ONU typically requires a separate subscriber unit to provide native user services such as telephony, Ethernet data, or video. In practice, the difference between an ONT and ONU is frequently ignored, and either term is used generically to refer to both classes of equipment. The ONTs are coupled to the OLT using a network of fibers and splitters referred to as an Optical Distribution Network (ODN). The ONT is a single integrated electronics unit that terminates the PON and provides an interface between the PON and the customer.

During operation, signals from the master control panel are transmitted to the ONT using a phone line. The security related information is then transmitted over the PON to the Central Alarm Monitoring Center. In all cases, ONT hardware and security system hardware, e.g. the master control panel, are separate components. For a customer to subscribe to services from both the ONT (Video/Voice/Data) and the security systems service, separate equipment is installed by different service providers. As a result, providing both ONT services and separate security services to a customer may require multiple service technicians to visit the structure, and also requires the service technicians to install separate components to enable the customer to receive both the ONT services and the security services.

A need remains for a system and method that is capable of providing both Video/Voice/Data and security services to a customer without utilizing separate components for each service.

### BRIEF DESCRIPTION OF THE INVENTION

In accordance with at least one embodiment, an optical network terminal (ONT) is provided that includes an input device coupled to at least one sensing device mounted in a structure, and an output coupled to a passive optical network (PON). The input devices may be IDC connections configured to receive a wire assembly that is coupled to the sensing device. The ONT also includes a processor programmed to receive security information from the input device, determine if an alarm condition exists using the security information, and transmit an alarm to the output based on the determination. The processor is programmed to detect an open circuit between the sensing device and the ONT, and to generate an alarm if an open circuit is detected. The processor is also programmed to receive information from a keypad located remotely from the ONT. The keypad is utilized to program the ONT from the remote location.

In accordance with another embodiment, a method is provided for operating a security system. The method includes receiving information from a sensing device mounted to a structure, utilizing an optical network terminal (ONT) to determine if an alarm condition exists, and transmitting an alarm to a passive optical network (PON) based on the determination. The method also includes detecting an open or a closed circuit between the sensing device and the ONT, and generating an alarm if an open circuit is detected. A security message is transmitted to a Central Alarm Monitoring Center if an alarm condition exists. The security message may include the location of the sensing device within the structure and the type of sensing device installed.

In accordance with another embodiment, a security system is provided that includes a processor installed in an optical network terminal (ONT), and a plurality of sensing devices mounted in a structure. The security system also includes a connector coupling each sensing devices to the processor. The processor is programmed to receive security information from the sensing devices, determine if an alarm condition exists using the security information, and generate an alarm based on the determination. The processor is also programmed to detect an open circuit between the sensing device and the connector, and to generate an alarm if an open circuit is detected. The sensing devices include at least one of a smoke detector, a heat sensor, a glass break detector, a door sensor, a motion detector, a moisture sensor, a carbon monoxide detector, a window sensor, and an environmental sensor.

In accordance with another embodiment, a computer readable medium is provided security system is provided for use in a security system having a programmable optical network terminal (ONT). The computer readable medium has instructions to direct the ONT to receive information from a sensing device mounted to a structure, and determine if an alarm condition exists. The computer readable medium also has instructions to direct the ONT to transmit an alarm to a central alarm monitoring center (CAMC) based on the determination.

### BRIEF DESCRIPTION OF THE DRAWINGS

FIG. 1 illustrates a block diagram of an optical distribution network utilized in connection with an embodiment of the present invention.

FIG. 2 illustrates a block diagram of an optical network terminal (ONT) that is implemented in accordance with an embodiment of the present invention.

FIG. 3 is a functional block diagram of exemplary components of the ONT shown in FIG. 2 in accordance with an embodiment of the present invention.

FIG. 4 is flowchart illustrating an exemplary method for operating a security system in accordance with an embodiment of the present invention.

FIG. 5 is a block diagram representing the operations of the exemplary method shown in FIG. 4 in accordance with an embodiment of the present invention.

FIG. 6 is another block diagram representing the operations of the exemplary method shown in FIG. 4 in accordance with an embodiment of the present invention.

FIG. 7 is an exemplary message that is transmitted in accordance with an embodiment of the present invention.

FIG. 8 is a block diagram of exemplary manners in which embodiments of the present invention may be stored, distributed and installed on computer readable medium.

### DETAILED DESCRIPTION OF THE INVENTION

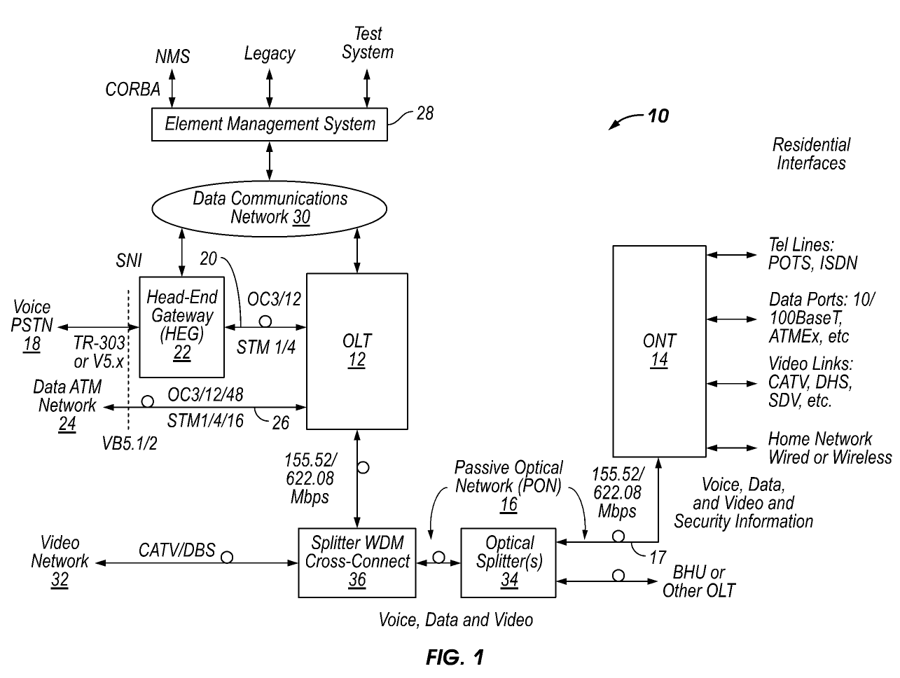

FIG. 1 illustrates a block diagram of an optical network 10 that is implemented in accordance with an embodiment of the present invention. In the exemplary embodiment, optical network 10 is a Full Service Access Network (FSAN) 10. The exemplary FSAN 10 includes an Optical Line Terminal (OLT) 12, at least one Optical Network Terminal (ONT) 14, and a Passive Optical Network (PON) 16 coupled between the OLT 12 and the ONT 14 for transporting voice, data, and/or video information to and/or from the ONT 14 via an ONT output 17. Optionally, PON 16 is an ATM Passive Optical Network (APON), a Broadband Passive Optical Network (BPON), or some other type of Passive Optical Network.

The OLT 12 preferably includes a Fiber Termination Shelf (not shown). The OLT 12 is connected to a voice public switched telephone network (PSTN) 18 preferably through an optical path 20 and a Head-End Gateway (HEG) 22. Optionally, the HEG 22 is integrated into the OLT 12. The preferred OLT 12 is connected to a Data ATM network 24 preferably through another optical path 26. The OLT 12 transfers voice and data information in a downstream direction to the PON 16 for forwarding to one or more ONTs 14 and transfers voice and data information received from the PON 16 upstream to the voice PSTN 18 and the Data ATM network 24, respectively. In addition, the preferred OLT 12 is connected to an Element Management System (EMS) 28 using a data communication network 30. During operation, EMS 28 provides for provisioning, error reporting, troubleshooting, testing and other network management operations.

In the exemplary embodiment, ONT 14 complies with the ITU-T G.983 Full Service Access Network (FSAN) requirements. The ONT 14 is configured and/or programmed to provide broadband and narrow-band services to a single residential unit, a multiple dwelling unit, or a commercial building. The narrow-band services may include telephony services such as POTS and ISDN. The broadband services may include high-speed data, video, and home networking. The ONT 14 transports high-speed data and telephony PCM traffic received, via the PON 16, from the OLT 12 to the customer. The ONT 14 also transports high-speed data and telephony PCM traffic received from the customer to the OLT 12, via the PON 16. The ONT 14 also receives video signals via the PON 16 from a video network 32 and provides the video signals to the residential unit.

Specifically, ONT 14 includes a plurality of interfaces for transmitting voice, data, video, security information, and other information between an end user or customer and an optical network. The exemplary ONT includes interfaces to support telephony lines such as POTS via RJ-11 connectors. The ONT 14 also includes an interface for network traffic such as a 10/100 Base-T network via RJ-45. The ONT 14 further includes an interface for video services such as CATV or DBS via an F-connector. The exemplary ONT 14, in addition includes, an interface for providing alarm and status indication information to the end user, an interface for receiving power from the end user, and an interface for other optional services.

For transferring voice, data, video, and other information between the ONT 14 and an optical network such as a PON 16. In the exemplary embodiment, downstream voice & data is received at a 1490 NM wavelength, downstream video is received at a 1550 NM wavelength, and upstream voice and data is transmitted at a 1310 NM wavelength on the fiber 41. With regard to its PON 16 interface, ONT 14 transmits upstream data & telephony at 1310 NM, receives downstream data & telephony at 1490 NM, and receives downstream Video at 1550 NM. The data rates handled by the preferred ONT 14 includes 155.52 Mbps downstream and 155.52 Mbps upstream but may optionally include 622.08 Mbps downstream and 155.52 Mbps upstream, 622.08 Mbps downstream and 622.08 Mbps upstream, or other bit rate combinations.

ONT 14 may also include a 10/100Base-T interface but may provide other interfaces such as a Gigabit Ethernet interface, an ATM Forum Interface, or a USB interface. The preferred BHU 100 employs fixed bandwidth allocation but optionally may employ dynamic bandwidth allocation. With regard to providing video services, ONT 14 provides full-bandwidth CATV (54 MHz-870 MHz) but may optionally provide limited-bandwidth CATV (54 MHz-370 MHz), DBS (950 MHz-2050 MHz), Switched Digital Video (SDV), and/or set-top box return. In regards to providing future services options, ONT 14 may make provisions for supporting a Home Wired Network and/or a Home Wireless Network.

In the exemplary embodiment, PON 16 includes one or more optical splitters 34 that are coupled between a splitter wavelength division multiplexer (WDM) Cross-Connect 36 and one or more ONTs 14. The preferred WDM cross-connect 36 has a fiber optic connection to a video network such as CATV or DBS, a fiber optic connection to the OLT 12 and a fiber optic connection to the PON 16. The WDM 36 provides connections for transferring video information from the video network 32 to the PON 16, and provides connections for transferring voice and data signals between the OLT 12 and the PON 16.

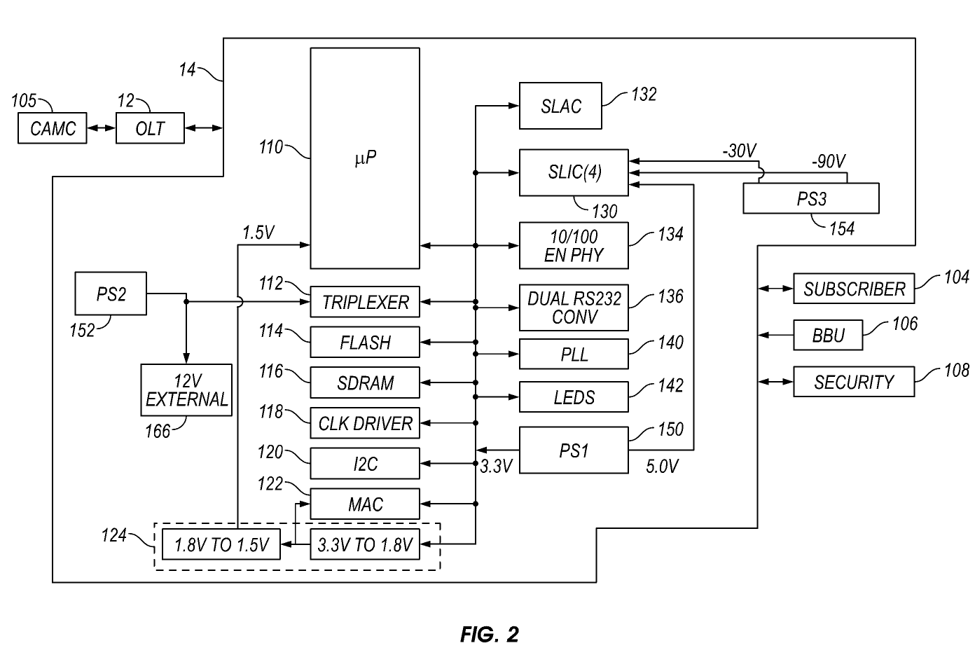

FIG. 2 illustrates a detailed block diagram of the ONT 14 shown in FIG. 1 in accordance with an embodiment of the present invention. The ONT 14 passes data, video, telephone signals, and security information between OLT 12 and an end user or subscriber 104. The ONT 14 also passes data, video, telephone signals, and security information between the subscriber 104 and a Central Alarm Monitoring Center (CAMC) 105 via OLT 12 as will be discussed below in more detail. ONT 14 includes a microprocessor 110 that controls the operation of ONT 14.

Among other things, the microprocessor 110 receives, processes, and manages storage of digitized data received from the OLT 12 and from various devices and sensors associated with the subscribers' premises. For example, the microprocessor 110 has the ability to receive signals from sensing devices 210, alarming device 250, and keypad 260.

In operation, the microprocessor 110 analyzes the data, for example, in connection with collecting, over a period of time, data collected from sensing devices 210. In operation, microprocessor 110 receives information from the input devices, e.g. sensing devices 210, determines if an alarm condition exists, and transmits an alarm to the output, e.g. OLT 12 and then to CAMC 105 based on the determination. In the exemplary embodiment, each of the IDC connections or ports 214 is provisioned with a customized alarm description. For example, the customized alarm description may include the type of sensing device 210 and the location within the structure of the sensing device 210. The customized alarm description is stored in the microprocessor or a memory circuit. The customized alarm description enables ONT 14 to identify the specific sensing device 210 generating the alarm, e.g. heat sensor in the basement, based on the assigned ONT port, e.g. connectors 214, to which the sensing device 210 is coupled.

The microprocessor 110 is coupled to the memory 114 and/or 116 by a suitable data/address bus, wherein the programmable operating parameters used by the microprocessor 110 are stored and modified, as required, in order to customize the operation of ONT 14 to suit the needs of the particular customer. The memories 114 and/or 116 may also store data indicative of alarm conditions. For example, as discussed below, each sensing device 210 outputs a specified voltage during a normal condition. However in the event of a security breach, i.e. the security sensor is activated or has been forcefully removed, the voltage output by the sensor is altered. In the event, the microprocessor 110 may store a table for example that indicates a normal operating voltage range for each attached sensing device 210. The table may also include an acceptable range of voltages for each sensing device 210, and generate an alarm condition if the voltage for a particular sensing device 210 falls outside of the acceptable range.

One of memories 114 and/or 116 therefore stores the algorithm utilized to generate an alarm based on data received from the sensing devices 210. For example, the memories 114 and/or 116 may store instructions that direct the microprocessor 110 to analyze the security data received from the sensing devices 210 and to detect changes in the status of the sensing devices 210. Further, the memories 114 and/or 116 may store instructions to direct microprocessor 110 to flag the identified changes related to the changes in the security data and to utilize the flagged data to activate an alarm at the business or residence and/or transmit the alarm condition to the CAMC 105, for example.

In addition to microprocessor 110, ONT 14 also includes a triplexer 112. The triplexer 112 is an optical transceiver that carries an upstream wavelength, a down stream wavelength, and a video overlay wavelength. ONT 14 also includes a flash memory 114, a RAM memory 116, a clock driver 118, and an I2C 120. The I2C is a multi-master serial computer bus that is used to attach low-speed peripherals to a motherboard, an embedded system, or the like. ONT 14 also includes a media access controller (MAC) 122, and a voltage converter 124. These devices, along with microprocessor 110 and triplexer 112, constitute the core logic devices of ONT 14.

To provide telephone service, ONT 14 also includes a number of, such as four, subscriber line interface circuits (SLICs) 130, which each provide interfaces to the phone lines of the subscribers, and a subscriber line audio-processing circuit (SLAC) 132, which provides an interface between the SLICs 130 and triplexer 112. ONT 14 additionally includes a 10/100 physical layer circuit 134, a dual RS232 converter 136, a phase locked loop 140, and a number of light emitting diodes (LEDs) 142. To provide security services, ONT 14 also includes an integrated security system that is configured to send and receive security information 108 to and/from the customers premises, i.e. subscriber 104, as discussed in more detail below.

ONT 14 may also include at least some of the following power supplies. For example, ONT 14 may a first power supply 150 that outputs first and second voltages, such as 3.3V and 5.0V, a second power supply 152 that outputs a third voltage, such as 12V, and a third power supply 154 that outputs fourth and fifth voltages, such as −30V and −90V. First, second, and third power supplies 150, 152, and 154 supply power from the AC main power supply when the AC main power supply is available, and from a backup battery 106 when the AC main power supply is no longer available.

As shown, each of the above devices (except for the other power supplies), is connected to the first power supply 150 to receive the first voltage (3.3V). In addition, the triplexer 112 and a 12V external source 166 are connected to the second power supply 152 to receive the third voltage (12V). Further, the SLICs 130 are also connected to the first power supply 150 to receive the second voltage (5V). The SLICs 130 are additionally connected to the third power supply 154 to receive the fourth and fifth voltages (−30V and −90V).

In operation, microprocessor 110 is programmed to control the operation of the ONT 14 based on various acquired signals. For example, the microprocessor 110 is programmed to receive information from at least one sensing device 210, and generally many sensing devices 210, that are mounted in a structure, e.g. the customer's home or business. The microprocessor is also programmed to utilize an optical network terminal (ONT) to determine if an alarm condition exists, and transmit an alarm to a passive optical network based on the determination. Typically, the microprocessor 110 includes the ability to process or monitor signals (e.g., data) as controlled by a program code stored in memory.

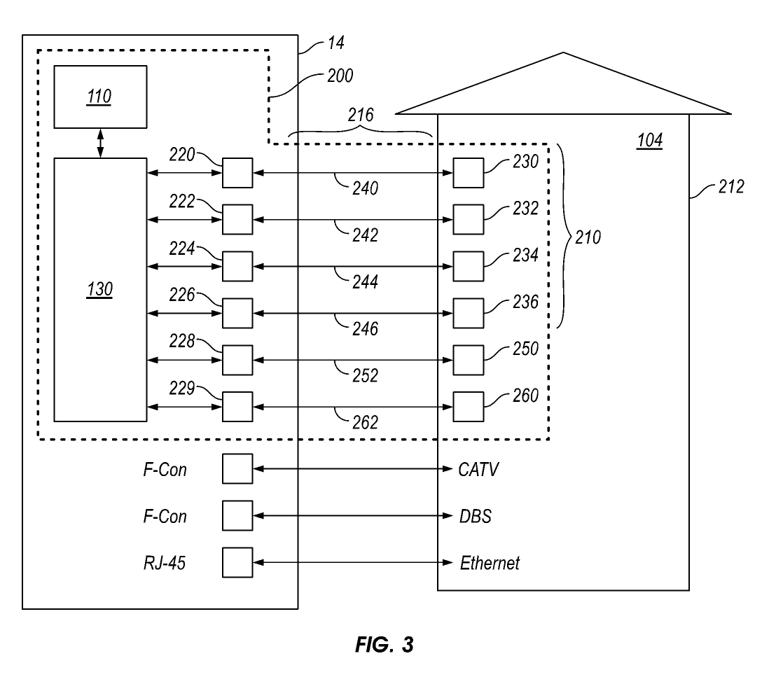

FIG. 3 is a more detailed block diagram of the ONT 14 shown in FIG. 2 in accordance with an embodiment of the present invention. As discussed above, known security systems include a master control panel that is installed within the customers premises. The known master control panel is connected to a known ONT using a telephone line for example. To facilitate reducing system components, and therefore reduce the cost of installation and service, ONT 14 includes an integral security system 200 that provides the functionality of the known master control panel. As a result, the sensing devices 210 are directly coupled to the ONT 14 without any intervening devices, i.e. the known master control panel may be eliminated.

More specifically, ONT 14 is configured to receive security related information directly from the plurality of sensing devices 210 mounted in the customers business or residence 212, i.e. the premises of subscriber 104 (shown in FIG. 2). ONT 14 is also configured to transmit security related information, from the CAMC 105, to the sensing devices 210. Residence as used herein may be a single family dwelling unit or a multi-family dwelling unit such as an apartment building for example. Moreover, although ONT 14 is shown coupled to a single dwelling unit 212, it should be realized that a plurality of dwelling units 212 may be coupled to a single ONT 14, a single multi-dwelling unit may be coupled to a single ONT 14, a multi-dwelling unit may be coupled to multiple ONTs 14, or one or more businesses may be coupled to a single or multiple ONTs 14 etc.

In the exemplary embodiment, sensing devices 210 may include door/window sensors that trigger an alarm if a secured door or window is opened while the system is armed. The sensing devices 210 may include motion detectors that monitor open areas and trigger an alarm based on movement and/or body heat. The sensing devices 210 may include smoke/heat detectors that detect smoke or unusually high temperatures, and generate an alarm indicating that a possible fire condition exists. The sensing devices 210 may include carbon monoxide detectors that detect dangerous levels of carbon monoxide. The sensing devices 210 may include glassbreak detectors that detect the sound of breaking glass, while ignoring the sounds of thunderstorms, telephones and other common noises. The sensing devices 210 may include flexible switches that each include a glassbreak detector and a window sensor. The sensing devices 210 may include heat sensors that are utilized when smoke detection is not desired to detect dangerously high temperatures. The sensing devices 210 may include environmental sensors that measure the temperature within an acceptable temperature range by setting the adjustable high and low limits. If the temperature in the monitored area rises above or drops below the set limits, the temperature sensor activates the security system. The sensing devices 210 may also include moisture sensors that identify water leaks or other undesirable moisture conditions.

In other options, the security system 200 may be configured to support Local Web Management wherein a customer is enabled to program the security system 200 from a personal computer within the customer's premise via the Internet or using a wireless transmitting device, etc. Moreover, security system 200 may be configured to support WebCam which enables a customer to access and control the webcam remotely.

As shown in FIG. 3, ONT 14 includes a plurality of connectors 214 that are utilized to couple sensing devices 210 to ONT 14. In the exemplary embodiment, the connectors 214 are insulation displacement connectors (IDCs) or insulation piercing connectors. Optionally, connectors 214 may be USB type connectors, etc. As such, any suitable connector may be utilized to couple sensing devices 210 directly to ONT 14. In use, IDC connectors 214 pierce the insulation surrounding a wire to make the connection, removing the need to strip the wire before connecting. Although FIG. 3 illustrates ONT 14 including four IDC connectors 214, e.g. 220, 222, 224, and 226, it should be realized that each ONT 14 may include less than four IDC connectors 214 but generally includes greater than four IDC connectors 214.

Each sensing device 210 is coupled to a respective IDC connector 214 via a wire assembly 216. In the exemplary embodiment, each wire assembly 216 includes a first copper wire and a second copper wire such that a closed electrical circuit, i.e. a loop, is formed between each sensing device 210 and each respective IDC connector 214. For example, during installation, a sensing device 230 is coupled to the connector 220 via a wire assembly 240, a sensing device 232 is coupled to the connector 222 via a wire assembly 242, a sensing device 234 is coupled to the connector 224 via a wire assembly 244, and a sensing device 236 is coupled to the connector 226 via a wire assembly 246. Optionally, wireless connectivity (802.11x) may be utilized to transmit information from the sensing devices 210 to ONT 14.

ONT 14 also includes at least one connector 228 that is used to couple ONT 14 to an alarming device 250 that is mounted to or within business or residence 212. In the exemplary embodiment, connector 228 is a plain old telephony (POTS) port that enables the alarming device 250 to be directly coupled to ONT 14 via a telephone line 252. For example, connector 228 may be an RJ11 connector to enable an alarming device 250 to be coupled to ONT 14 via a single telephone line. Optionally, RJ14, RJ25, or RJ61 connectors may be utilized to couple multiple alarming devices 250 to ONT 14. In another embodiment, connector 228 may be embodied as a USB port.

The alarming device 250 may be embodied as an external siren, an interior siren, or a strobe light, for example. The external siren generates an audible alarm of sufficient strength to notify an intruder that the security system 200 has been triggered. The interior generates an audible alarm of sufficient strength to notify the persons within the business or residence 212 that the security system 200 has been triggered. The strobe light generates a visual indication for assisting emergency personnel in locating the business or residence 212 in which the alarm has been triggered. In another embodiment, the alarming device 350 may generate a “silent” alarm that is transmitted to the CAMC 105 to alert the authorities that an alarm has been generated without alerting persons in the business or residence 212.

ONT 14 also includes at least one connector 229 that is used to couple a keypad 260 directly to ONT 14. In the exemplary embodiment, connector 229 is a POTS port that enables the keypad 260 to be directly coupled to ONT 14 via a telephone line 262. As shown in FIG. 3, the keypad 260 is generally mounted within the business or residence 212 in a location that provides easy access to the customer.

In use, the keypad 260 controls or manages the operation of the security system 200. For example, the keypad 260 includes an alarm inhibit feature that allows a customer to disarm the security system 200 to inhibit alarms from being generated. The keypad 260 also includes a feature to arm the security system 200, or to arm certain sensing devices 210 while simultaneously disarming other sensing devices 210. During operation, the keypad 260 is programmed to receive a predefined security code that is entered by an operator. The security code enables an authorized operator to configure and/or monitor the security system 200 and inhibits an unauthorized operator from altering or disarming the security system 200. Moreover, the keypad 260 is capable of being provisioned using a programmable sequence of DTMF tones.

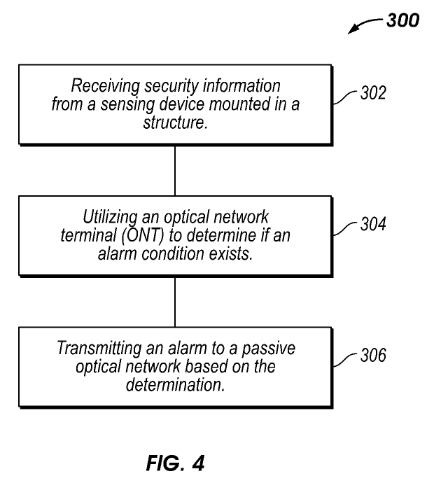

FIG. 4 is a flowchart illustrating an exemplary method 300 for operating the security system 200. The method includes receiving 302 security information from a sensing device 210 mounted in a structure 212, utilizing 304 an optical network terminal (ONT) 14 to determine if an alarm condition exists, and transmitting 306 an alarm to a passive optical network 16 based on the determination.

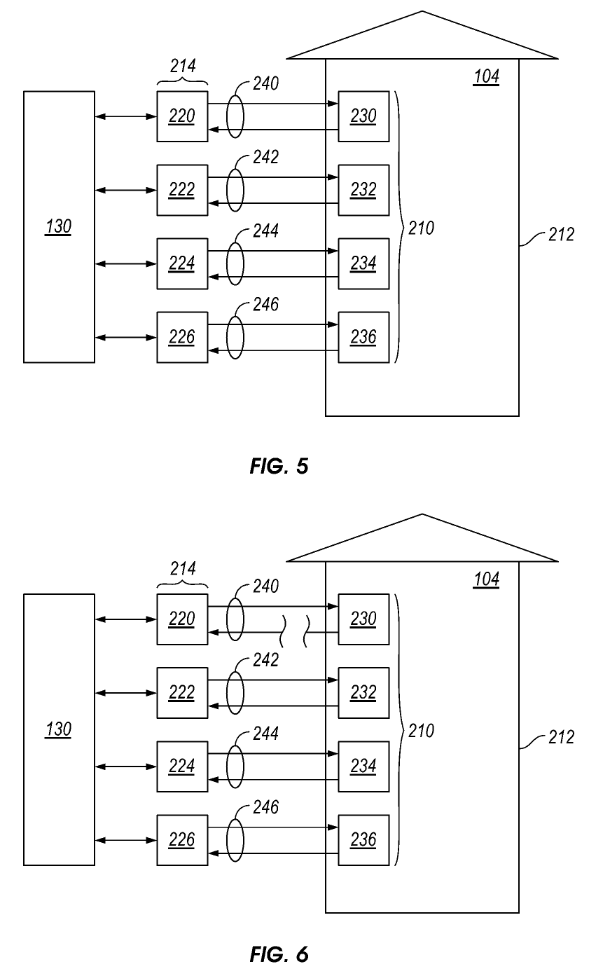

During operation, security system 200 is armed or activated using keypad 260. Once the security system 200 is armed, all the installed sensing devices 210 will be activated and “listen” for triggering activities. For example, FIG. 5 illustrates security system 200 during one mode of operation when no alarms have been triggered. As discussed above, each sensing device 210 is coupled to the ONT 14 via the IDC connectors 214. Moreover, each sensing device 210 is coupled to ONT 14, using a pair of copper wires 240 for example, such that a continuous circuit or electrical path is formed between the ONT 14 and each respective sensing device 210. During the first mode of operation, i.e. no sensing device 210 is triggered, the electrical path between the sensing device 210 and the ONT 14 is “closed”. More specifically, the ONT 14 is continuously receiving a voltage signal from each respective sensing device 210. The microprocessor 110 continuously evaluates the voltage signals received from each respective sensing device 210 to determine if the voltage signal is within the predetermined setpoint stored for each respective sensing device 210.

For example, referring specifically to sensing device 230, assuming that sensing device 230 has not been triggered, sensing device 230 may output a voltage signal of five volts. Microprocessor 110 receives this voltage signal and compares the voltage signal to a database stored within the ONT 14. As discussed above, each sensing device 210 is connected to ONT 14 via a connector 214, also referred to herein as a port. During installation, a database is generated that includes information for each sensing device 210 that is coupled to ONT 14. The information includes at least, the type of sensing device 210, the port or connector 214 to which the sensing device 210 is coupled, the location of the sensing device 210 within the structure, and the typical or nominal operating voltage of the sensing device 210. The sensing device information is typically stored as a database in microprocessor 110 or memory 114/116 for example. It should be realized that a wide variety of sensing devices 210 may be utilized in security system 200. It should also be realized that different sensing devices 210 provide different outputs or voltage levels during normal operation. As such, the database is configured to store operational information for each specific sensing device 210. The operational information may include voltage outputs of the sensing device 210 during a non-activated or non-alarming state, a range or threshold of acceptable voltage outputs during the non-activated or non-alarming state, a voltage output of the sensing device 210 during an activated or alarming state, and/or a range or threshold of acceptable voltage outputs during the activated or alarming state.

In this example, the ONT 14 receives a five volt signal from sensing device 230. Microprocessor 110 compares the voltage received from sensing device 230 to the threshold voltage stored in the database, e.g. five volts, and determines that the voltage signal is normal, i.e. within the predetermined threshold. Since, the microprocessor 110 has determined that no alarm has been generated, no further action is taken by ONT 14.

In a second mode of operation shown in FIG. 6, at least one sensing device 210 has been triggered indicating an alarm condition. As such, the electrical path between ONT 14 and the sensing device 210 has been interrupted, i.e. the path is “open”. For example, referring again specifically to sensing device 230, assuming that sensing device 230 has been triggered, as illustrated by a break in wiring assembly 240, the voltage measured by microprocessor 110 is approximately zero volts. In this case, the microprocessor 110 determines that the voltage signal is not within the predetermined threshold and as such is not acceptable. ONT 14 then generates an alarm or message which is transmitted to OLT 12 via PON 16 as will be discussed below.

Generally, ONT 14 determines whether a specific sensing device 210 is triggered or not by determining whether the circuit between ONT 14 and each sensing device 210 is either “open” or “closed”. If the circuit is “closed” the respective sensing device 210 is not triggered. Specifically, if the circuit is closed, the voltage output of the sensing device 210 is within the acceptable range or threshold as discussed above. If the circuit is “open” the respective sensing device 210 is triggered, indicating that an alarm condition exists. When the microprocessor 110 detects the circuit transition from “close” to “open”, the ONT 14 automatically generates a message that is transmitted via the ONT Management Control Interface to the OLT 12 and the EMS 28. Based on the information stored in the microprocessor database, the message may include the type of sensing device 210 and the location of the sensing device 210. For example, the message may include information such as a heat sensor has been activated in the kitchen. Moreover, depending on the type of sensing device 210 utilized, additional information may be included in the message. For example, assuming sensing device 210 is a heat sensor installed in a kitchen, the message may include the temperature within the kitchen. As another example, assuming the sensing device 210 is a water sensor installed in an office, the message may include the level of water within the office, etc.

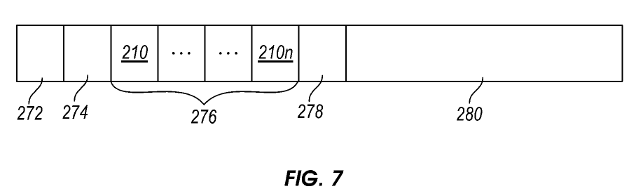

FIG. 7 illustrates an exemplary data packet or security message 270 that is transmitted from the ONT 14 to the OLT 12 when an “open” circuit is detected for any of the sensing devices 210. The exemplary message 270 is a fixed length message that generally includes assigned locations within the message 270 that are utilized to transmit the security information. For example, in the exemplary embodiment, message 270 includes a header 272 including the destination address, e.g. the OLT12 to receive the message, or an originating address, e.g. the ONT 14 sending the message. The message 270 may also include a security flag 274 that indicates that at least one sensing device 210 has been activated, i.e. an alarm condition exists. Message 270 may also include a data block 276 assigned to each installed sensing device 210, e.g. n data blocks for n sensing devices 210. Assuming that sixteen sensing devices 210 are coupled to ONT 14, message 270 may include sixteen bits or data blocks 276, wherein each bit is assigned to a respective sensing device 210. For example, when a sensing device 210 is activated or alarmed the respective message bit is true or 1, otherwise the message bit is 0. Message 270 may also include a data field 278 that includes the type of sensing device 210 and/or the location of the sensing device 210 in the structure. Message 270 may also include a message field 280 that includes other data, such as the temperature, pressure, water level, etc. A management system, such as the EMS 28, is configured to report each alarm sent by each of the sensing devices 210 which include the alarm ID, e.g. the location of the sensing device 210, as well as the customized alarm, e.g. temperatures, etc. In the exemplary embodiment, EMS 28 notifies the CAMC 105 that an alarm has been generated. In one embodiment, EMS 28 transmits the alarm message to the CAMC 105 and/or the customer via email. Optionally, the alarm message may be transmitted via phone line, etc. The technician at the CAMC 105 that is informed of this alarm, then takes action to notify the perspective authorities and the customer. In the exemplary embodiment, the alarm condition can be disarmed either by the customer using the keypad 260 or by the technician at the CAMC 105.

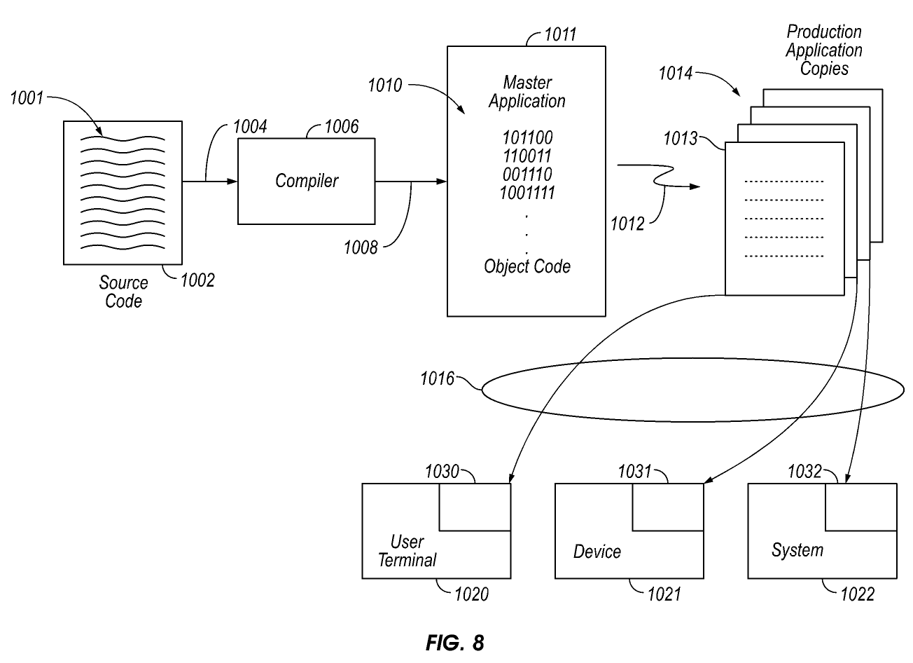

FIG. 8 illustrates a block diagram of exemplary manners in which embodiments of the present invention may be stored, distributed and installed on computer readable medium. In FIG. 8, the “application” represents one or more of the methods and process operations discussed above. For example, the application may represent the process carried out in connection with FIGS. 1-6 as discussed above.

As shown in FIG. 8, the application is initially generated and stored as source code 1001 on a source computer readable medium 1002. The source code 1001 is then conveyed over path 1004 and processed by a compiler 1006 to produce object code 1010. The object code 1010 is conveyed over path 1008 and saved as one or more application masters on a master computer readable medium 1011. The object code 1010 is then copied numerous types, as denoted by path 1012, to produce production application copies 1013 that are saved on separate production computer readable medium 1014. The production computer readable medium 1014 is then conveyed, as denoted by path 1016, to various systems, devices, terminals and the like. In the example of FIG. 8, a user terminal 1020, a device 1021 and a system 1022 are shown as examples of hardware components, on which the production computer readable medium 1014 are installed as applications (as denoted by 1030-1032). Moreover, the computer readable medium may be stored in memory 114 or 116, microprocessor 110, or a hard drive, for example.

The source code may be written as scripts, or in any high-level or low-level language. Examples of the source, master, and production computer readable medium 1002, 1011 and 1014 include, but are not limited to, CDROM, RAM, ROM, Flash memory, RAID drives, memory on a computer system and the like. Examples of the paths 1004, 1008, 1012, and 1016 include, but are not limited to, network paths, the internet, Bluetooth, GSM, infrared wireless LANs, HIPERLAN, 3G, satellite, and the like. The paths 1004, 1008, 1012, and 1016 may also represent public or private carrier services that transport one or more physical copies of the source, master, or production computer readable medium 1002, 1011 or 1014 between two geographic locations. The paths 1004, 1008, 1012 and 1016 may represent threads carried out by one or more processors in parallel. For example, one computer may hold the source code 1001, compiler 1006 and object code 1010. Multiple computers may operate in parallel to product the production application copies 1013. The paths 1004, 1008, 1012, and 1016 may be intra-state, inter-state, intra-country, inter-country, intra-continental, intercontinental and the like.

The operations noted in FIG. 8 may be performed in a widely distributed manner world-wide with only a portion thereof being performed in the United States. For example, the application source code 1001 may be written in the United States and saved on a source computer readable medium 1002 in the United States, but transported to another country (corresponding to path 1004) before compiling, copying and installation. Alternatively, the application source code 1001 may be written in or outside of the United States, compiled at a compiler 1006 located in the United States and saved on a master computer readable medium 1011 in the United States, but the object code 1010 transported to another country (corresponding to path 1012) before copying and installation. Alternatively, the application source code 1001 and object code 1010 may be produced in or outside of the United States, but product production application copies 1013 produced in or conveyed to the United States (e.g. as part of a staging operation) before the production application copies 1013 are installed on user terminals 1020, devices 1021, and/or systems 1022 located in or outside the United States as applications 1030-1032.

As used throughout the specification and claims, the phrases “computer readable medium” and “instructions configured to” shall refer to any one or all of i) the source computer readable medium 1002 and source code 1001, ii) the master computer readable medium and object code 1010, iii) the production computer readable medium 1014 and production application copies 1013 and/or iv) the applications 1030-1032 saved in memory in the terminal 1020, device 1021 and system 1022.

Described herein is an Optical Network Terminal (ONT) that includes an integrated security system that increases the value of the ONT by providing additional features. The ONT 14 reduces installation time, reduces the quantity of equipment to be installed at the customer premises, enables service providers to offer security systems services to their customers, provides a security system provider with alternative equipment, and provides for centralized management of ONT Services and Security System Service.

ONT 14 also supports various security sensors including, but not limited to, door/window sensors, motion detectors, smoke/heat detector, carbon monoxide detectors, flex switches, glassbreak detectors, heat sensors, environmental alerts, and moisture sensors. Specifically, ONT 14 includes multiple IDC connectors that are triggered by external events. A microprocessor 110 is utilized to detect a “Closed” or “Opened” condition of the connectors. A pair of copper wires are utilized to couple the sensors to the ONT 14 to form a closed or looped circuit. When a sensor is triggered, the sensor opens the two wires that go to the sensor to form an opened circuit. The connectors are configurable at the ONT 14 such that when the microprocessor, via the IDC connector, detects an “Open” circuit condition, ONT 14 triggers an autonomous alarm which is sent upstream, via OMCI, to the Management System.

ONT 14 is capable of supporting multiple IDC connections and thus support multiple sensors being coupled to ONT 14. The microprocessor, via the IDC connection, has the ability to detect a “Closed” or “Opened” circuit condition. When a circuit transition from “Close” to “Open” is detected, ONT 14 sends an autonomous alarm via OMCI to the OLT and the EMS. Each of the IDC connections can be provisioned with customized alarm description. The Management System, e.g. EMS 28, is configured to report alarms sent by ONT 14. The alarms will indicate the assigned ID of the sensing device 210 as well as the customized alarm description.

The ONT 14 is configured to transmit the security information received from the multiple sensors to the OLT 12 at a frequency that is different than the frequency used to transmit the voice and video data. For example, in the exemplary embodiment as discussed above, the voice data may be transmitted at 1310 NM wavelength and the video data may be transmitted at 1550 NM. The voice data is transmitted at any wavelength that is different than the wavelength used to transmit the video data. In this exemplary embodiment, the security data may be transmitted at any wavelength that is different than the 1310 and 1550 wavelengths discussed above. Optionally, the security information may be transmitted at 1310 or 1550 NM wavelength. In another exemplary embodiment, the security information may be transmitted at any wavelength used by the ONT 14 to transmit any information that is transmitted by ONT 14 over the passive optical network.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the embodiments of the present invention without departing from its scope. While the dimensions, types of materials and coatings described herein are intended to define the parameters of the embodiments of the present invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

While the invention has been described in terms of various specific embodiments, those skilled in the art will recognize that the embodiments of the present invention can be practiced with modification within the spirit and scope of the claims.

What is claimed is:

1. An optical network terminal (ONT) comprising:
an input device coupled to at least one sensing device mounted in a structure;
an output coupled to a passive optical network (PON); and
a processor programmed to receive security information from the input device, determine if an alarm condition exists using the security information, and transmit an alarm to the output based on the determination.

2. An ONT in accordance with claim 1 wherein said input device comprises an insulation displacement connector or a USB port.

3. An ONT in accordance with claim 1 wherein said output comprises an optical fiber coupled between said ONT and said PON.

4. An ONT in accordance with claim 3 wherein said fiber optic output is coupled to an optical line terminal (OLT) via the passive optical network;

5. An ONT in accordance with claim 1 wherein said processor is programmed to detect an open circuit between said sensing device and said input device, and to generate an alarm if an open circuit is detected.

6. An ONT in accordance with claim 1 wherein said sensing device comprises at least one of a smoke detector, a heat sensor, a glass break detector, a door sensor, a motion detector, a moisture sensor, a carbon monoxide detector, a window sensor, and an environmental sensor.

7. An ONT in accordance with claim 1 wherein said processor is further programmed to receive information from a keypad located remotely from said ONT, said processor is programmable using the information received from the remote keypad.

8. An ONT in accordance with claim 1 further comprising a device configured to generate at least one of a visual indication and an audible indication if an alarm condition exists.

9. An ONT in accordance with claim 8 wherein said device comprises a siren coupled to at least one of an interior surface of the structure and an exterior surface of the structure.

10. An ONT in accordance with claim 1 wherein said processor is further programmed to transmit the security information over the passive optical network at a frequency that is different than the frequency used to transmit voice and video data.

11. A method for operating a security system, said method comprising:
receiving information from a sensing device mounted to a structure;
utilizing an optical network terminal (ONT) to determine if an alarm condition exists; and
transmitting an alarm to a passive optical network (PON) based on the determination.

12. A method in accordance with claim 11 further comprising:
detecting an open or a closed circuit between the sensing device and the ONT; and
generating an alarm if an open circuit is detected.

13. A method in accordance with claim 11 further comprising transmitting a security message to a Central Alarm Monitoring Center if an alarm condition exists.

14. A method in accordance with claim 11 wherein each sensing device is coupled directly to a respective connector on the ONT, said method further comprising:
determining a location of the sensing device within the structure based on the connector; and
transmitting a message that includes the sensing device location to a Central Alarm Monitoring Center if an alarm condition exists.

15. A method in accordance with claim 14 wherein each connector is assigned a customized alarm description, said method further comprising transmitting a message that includes the customized alarm description to a Central Alarm Monitoring Center if an alarm condition exists.

16. A method in accordance with claim 11 further comprising generating at least one of a visual indication and an audible indication when an alarm is generated.

17. A method in accordance with claim 11 further comprising:
receiving at least one of voice, data, and video information from the structure; and
transmitting the voice, data, video, and sensing device information to the PON.

18. A method in accordance with claim 11 further comprising transmitting the security information over the passive optical network at a frequency that is different than the frequency used to transmit voice and video data.

19. A security system comprising:
a processor installed in an optical network terminal (ONT);
a plurality of sensing devices mounted in a structure; and
a connector coupling each said sensing devices to said processor, said processor programmed to receive security information from the sensing devices, determine if an alarm condition exists using the security information, and generate an alarm based on the determination.

20. A security system in accordance with claim 19 wherein said sensing devices comprise at least one of an insulation displacement connector and a USB port.

21. A security system in accordance with claim 19 wherein said processor is programmed to detect an open circuit between said sensing device and said connector, and to generate an alarm if an open circuit is detected.

22. A security system in accordance with claim 19 wherein said sensing device comprises at least one of a smoke detector, a heat sensor, a glass break detector, a door sensor, a motion detector, a moisture sensor, a carbon monoxide detector, a window sensor, and an environmental sensor.

23. A security system in accordance with claim 19 further comprising a keypad located remotely from said processor, said keypad configured to program said processor.

24. A computer readable medium for use in a security system having a programmable optical network terminal (ONT), the computer readable medium having instructions to direct the ONT to:
receive information from a sensing device mounted to a structure;
determine if an alarm condition exists; and
transmit an alarm to a central alarm monitoring center (CAMC) based on the determination.

25. The computer readable medium of claim 24, wherein the instructions further direct the ONT to:
detect an open or a closed circuit between the sensing device and the ONT; and
generate an alarm if an open circuit is detected.

26. The computer readable medium of claim 24, wherein the instructions further direct the ONT to:
determine a location of the sensing device within the structure; and
transmit a message that includes the sensing device location to the Central Alarm Monitoring Center if an alarm condition exists.

27. The computer readable medium of claim 24, wherein the instructions further direct the ONT to transmit a message that includes a customized alarm description to the Central Alarm Monitoring Center if an alarm condition exists.
